(19) United States
(12) Patent Application Publication
(10) Pub. No.: US 2006/0155834 A1
(43) Pub. Date: Jul. 13, 2006

(54) Signalling in controlled active networks

(76) Inventors: Thomas Levy, Paris (FR); Olivier Marce, Massy (FR)

Correspondence Address: SUGHRUE MION, PLLC, 2100 PENNSYLVANIA AVENUE, N.W., SUITE 800, WASHINGTON, DC, 20037, US

(21) Appl. No.: 10/541,694

(22) PCT Filed: Dec. 1, 2003
(86) PCT No.: PCT/FR03/03551

§ 371 Date: Aug. 5, 2005

(30) Foreign Application Priority Data
Jan. 10, 2003 (EP) 03290056.5

(51) Int. Cl. G06F 15/177

(52) U.S. Cl. 709/221

(57) ABSTRACT

The invention relates to a controlled telecommunications network and a signaling method for use in a network of that kind, which comprises active nodes (11) and signaling control units (3, 4). The method comprises the steps of reception by a signaling unit of a virtual circuit request (5) from a client terminal (1), setting up that circuit between the client terminal (1) and a server terminal (2), and negotiation between the terminals (1, 2) and the signaling control units (3, 4) of the characteristics to be assigned to a data stream (10) that has to cross the network. The following steps are then added: determination of the appropriate active codes, decision on a strategy for deployment of the active codes by the signaling control units, and then deployment (8) of the active codes among the active nodes (11) of the network from one or more signaling units (3, 4).

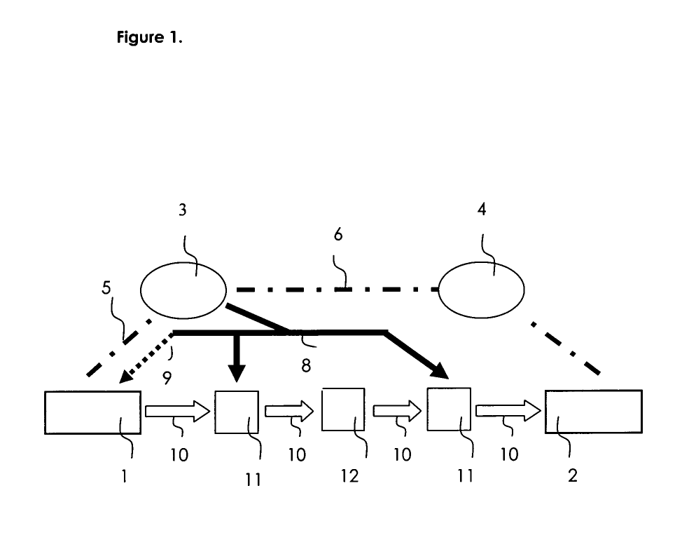

The invention relates to controlling active telecommunications networks and applies in particular to networks using the Internet Protocol.

In the field of conventional telephony, signaling control units route service signals exchanged by the telephone terminals and the telephone exchanges through which a call passes. These signals may in particular include information on the coordinates of a telephone terminal that is the target of a call request, the status (busy/free) of a line, the duration of a call and the billed amount. Prior art signaling control units include SIP proxy and softswitch servers.

Various prior art protocols, including the Session Initiation Protocol (SIP) and the H323 protocol, enable the signaling control units to communicate with a network using the Internet Protocol (IP), known as an IP network. The Session Initiation Protocol is covered by standards issued by the Internet Engineering Task Force (IETF) and dates from 1999. Like the H323 protocol, which is covered by standards issued by the International Telecommunication Union (ITU) and was introduced in 1996, it regulates exchanges between data transfer applications in real time over IP networks.

The concept of the networks known in the art as “active networks” was introduced by the Defense Advanced Research Projects Agency (DARPA) in 1994 and was the subject matter of a first international conference held in 1999: “International Workshop on Active Networks (IWAN 99)”.

The above-cited prior art defines an active network as a network in which certain components (in particular the nodes of the network) are programmable dynamically by connected entities such as operators, service providers, users, or applications. The dynamic programming may relate to signaling, supervision, or data to be transmitted.

In an active network, applications are distributed throughout the network and are no longer executed only at the extremities of the network (for example by client and server terminals). The network is referred to as an “active” network, as opposed to a “passive” network whose nodes (or routers) have the main task of switching data, i.e. of circulating data.

To facilitate its circulation, the data is conventionally divided into packets of data known as datagrams.

Certain programmable or active nodes of an active network handle a portion of the applications (for example multimedia applications) and are able to change their behavior dynamically in order to perform processing that is specific to client-server applications.

In addition to active components, active networks retain conventional network components such as the servers that are mandatory for effecting a connection between two sub-networks of a network. This is known in the art. Such components may comprise at the very least a computer connected to the network.

An active code is a code (or program) that can be executed by a computer. The active code is usually contained in or referred to in a data stream received by the active nodes (or routers) and is executed at the nodes in a given execution environment. This kind of architecture in particular enables the functions of the network to be modified on demand, for example according to the nature of the data to be transmitted.

Any network application can exploit the flexibility of an active network. In particular, the codes deployed in the active nodes enable dynamic adaptation of quality of service (QoS) and routing to the instantaneous conditions to which the network is subjected (network congestion, unavailability of a route, etc.). The deployment of active codes also enables video and audio coding techniques to be adapted to the Internet.

For multimedia over IP applications, the code to be deployed is determined from the client or user terminal requesting the transfer of data.

Allowing any application of a user to associate active code with the data stream may lead to problems of mismatching between the stream characteristics required by the application and the instantaneous status of the network.

An object of the invention is to solve this problem.

The invention therefore proposes an active telecommunications network comprising an active node comprising active code reception means and an active code execution environment and a signaling control unit comprising means for receiving a request to set up a virtual circuit between a client terminal and a server terminal, virtual circuit set-up means, and means controlled by the virtual circuit set-up means for sending active code to the active node.

In a first preferred embodiment, the signaling control unit further comprises an active code library, and means for selecting active code in the library.

In this case, it may be particularly advantageous if the signaling control unit further comprises active code compilation means.

In another preferred embodiment, the signaling control unit of the active telecommunications network of the invention further comprises means for generating active code on the fly.

In another preferred embodiment, the signaling control unit of the active telecommunications network of the invention uses the Internet Protocol.

The invention also provides a signaling method for use in a telecommunications network of the invention, the method comprising a step of sending an appropriate active code from the signaling control unit to the active node.

A first preferred embodiment of the method comprises a step of deciding on a strategy for sending of the appropriate active code by the signaling control unit prior to the sending step.

A first preferred embodiment of the method of the invention comprises a step of the signaling control unit determining the appropriate active code prior to the sending step and optionally prior to the strategy decision step.

In this case it is advantageous if the method comprises a step prior to the determination step of negotiation between the terminals and the signaling control unit of the characteristics of a communications session.

Another preferred embodiment of the method of the invention comprises a step prior to the negotiation step of the signaling control unit receiving the virtual circuit request and setting up the virtual circuit.

When the control unit comprises the active code library and selection means, it is also advantageous for the determination step to comprise the selection by the control unit of the appropriate active code in the library.

When the control unit comprises active code generation means, it is also advantageous for the determination step to comprise the generation of the appropriate active code on the fly by the control unit.

The invention is described in more detail below by describing currently preferred embodiments with reference to the single FIGURE of the appended drawing, which is a diagram of the deployment of active codes by a signaling control unit 3 among the active nodes of an active network.

The FIGURE represents a virtual circuit request (call request) 5 sent from a client terminal 1 to a server terminal 2. The two terminals are connected to the network, which further includes one or more signaling control units 3, 4 and routing systems (or nodes), of which some nodes 11 are active nodes and other nodes 12 are not active nodes.

The invention therefore relates to an active telecommunications network including an active node 11 comprising active code receiving means and an active code execution environment and a signaling control unit 3 comprising means for receiving a request 5 to set up a virtual circuit between a client terminal 1 and a server terminal 2, means for setting up virtual circuits, and means for sending active code to the active node. These sending means, controlled indirectly or not by the virtual circuit set-up means, handle the deployment 8 of an appropriate active code to the active node 11 from the signaling control unit 3.

The active nodes comprise means for receiving an active code and an execution environment for processing the code, for example the execution environment of a Java virtual machine. The terminals may be standard personal computers (PC) for example, running multimedia applications such as applications for playing streaming video or audio stored on a remote computer.

The terminals may equally be Voice over IP telephone terminals.

Setting up the virtual circuit is managed by one or more signaling control units 3, 4. The number of signaling control units used to set up a call depends on the location of the terminals concerned in terms of their network. These units comprise means for receiving a virtual circuit request 5 from a client terminal 1 and means for setting up a virtual circuit between the client terminal 1 and a server terminal 2. Such means may use the H323 protocol or the Session Initialization Protocol known in the art and all the means for communicating with an IP network with which signaling control units are conventionally provided. The virtual circuit set-up means control the means for sending active code to the active node, as explained next.

At least some of the signaling control units 3, 4 preferably comprise active code determination means. Active code determination may be effected in several steps, as described hereinafter.

Once the virtual circuit has been set up, the terminals 1, 2 and the signaling control units 3, 4 can exchange information. The terminals 1, 2 and the signaling control units 3, 4 can then agree on the characteristics to be assigned to the communications session during a negotiation step. Following this negotiation step, the characteristics concerned may differ from the characteristics required by an application on the client terminal 1. The negotiation includes exchanges of information on the instantaneous status of the network and may also take account of the characteristics required by the application on the client terminal 1. The negotiated characteristics may in particular include the bandwidth and the routing of the data stream (i.e. the circuit consisting of the nodes that will be used to set up the call between the terminals 1 and 2). However, this negotiation may be restricted to simple communication of characteristics that may be assigned.

The result of the negotiation may then be used by one or more of the signaling control units, for example the unit 3 handling the virtual circuit request 5, to determine the active codes to be sent (or deployed) and a strategy for sending (or deploying) those codes. One or more of the signaling control units, for example the unit 3 handling the virtual circuit request 5, may execute an algorithm to determine the appropriate active codes, for example, i.e. the active codes that will provide the characteristics negotiated during the negotiation step. The active code determined by this algorithm has two important roles. The first is to ensure that the data packets of the call are transmitted appropriately, given the negotiated characteristics. The second role is to ensure the execution of corrective measures necessary for the effective level of service offered for the call to correspond to the negotiated theoretical level of service.

The decision in respect of the sending (or deployment) strategy may then take account of the number of active codes to be deployed and the number of active nodes liable to execute those codes, for example.

The deployment of the appropriate active codes among the nodes 11 of the network is effected from one or more of the signaling control units, for example the unit 3 handling the virtual circuit request 5. As described above by way of illustration, the appropriate codes may be obtained in different ways.

Moreover, the deployment of the active codes may be selective, i.e. a particular code may be assigned to a particular node.

Deploying the active codes from the signaling control units enables the active network to offer functions adapted to the transmission of the data stream 10 (for example a multimedia data stream). This kind of advantage can be obtained by virtue of the fact that a signaling control unit has an overview of the network at a given time, unlike the nodes and the terminals, which have only a local view of the network. As described in the document EP-A-1 204 246, if an active code is sent over an IP network from one IP terminal to another IP terminal, it affects all of the nodes through which it passes to varying degrees depending on the method used. In this kind of situation, the absence of an overview of the network by its nodes complicates the sending of a particular code to a particular node.

Moreover, deploying active codes from signaling control units rather than a terminal avoids mismatch problems and prevents certain malicious acts. A particular type of code deployed by a user terminal could seek to obtain transmission characteristics different from those negotiated during a signaling step or those provided by a provider of services to the user, which the present invention guards against.

In the present context the expression “active code” must be understood in a broad sense, i.e. that of a message possibly including a header consisting of the specific features of the code (in particular the address of the destination node and the execution environment), and the executable code itself, as described in EP-A-1 204 246, for example. This kind of active code structure means that a particular node can be targeted and therefore assigned a particular code during the active code deployment step.

Moreover, the concept of “active code receiving, deployment, etc. means” refers to means operating with one or more active codes.

If only one active node is available on the network, the sending strategy is adapted accordingly and the appropriate active code(s) are routed to that node. If a plurality of active nodes is available, the active codes are routed to each of those nodes in accordance with the strategy decided upon.

The functions offered by the active codes deployed in the active nodes further provide for supervising messages tracking the data stream conforming to any media protocol, such as the Real-time Transport Control Protocol (RTCP), thus enabling dynamic adaptation of the network to the quality required for the sending step 9.

In a variant, one or more of the signaling control units 3, 4 can comprise a pre-compiled active code library (not shown in the FIGURE). In this variant, the signaling control unit comprising the library, for example the unit 3, selects the appropriate active codes from among those available in the library, following the step of negotiation involving the signaling control units 3, 4 and the terminals 1, 2.

In another variant, the signaling control unit 3 that comprises the library also comprises compilation means for compiling the selected active codes if they are available only in the uncompiled state. These means may consist in executable programs installed on the signaling control unit itself, for example, or on another machine controlled by the signaling control unit 3.

In a further variant, compilation is effected to match a dynamic architecture of the active nodes 11 (which type of compilation for a code to be executed in which type of environment available on which node, etc.). To this end, the signaling control unit executes an appropriate algorithm. For example, on the basis of the negotiation effected in real time, the signaling control unit triggers the execution of a compilation program selected from the various programs available and corresponding to various execution environments.

In a still further variant, appropriate active codes are generated on the fly by a signaling control unit 3 on the basis of the result of the negotiation that is effected in real time and enables the source code most appropriate to the negotiation to be generated, followed by compiling it in accordance with a dynamic architecture of the active nodes 11 before deploying the compiled appropriate codes among the nodes of the network.

The above control examples are not limiting on the invention. Thus the invention applies equally to packet-mode calls, independently of the IP protocol. Moreover, the invention also applies to teleconferences managed by a central terminal, in which it is possible to treat each terminal participating in the conference as a client telephone terminal 1 and the central terminal as a server terminal 2. Similarly, other teleconference configuration schemes may be broken down into elementary schemes involving a client-server terminal pair and to which the invention may be applied, as will be obvious to the person skilled in the art.

1. An active telecommunications network comprising:
an active node (11) comprising active code reception means and an active code execution environment; and
a signaling control unit (3) comprising:
means for receiving a request (5) to set up a virtual circuit between a client terminal (1) and a server terminal (2);
virtual circuit set-up means; and
means controlled by the virtual circuit set-up means for sending active code to the active node.

2. A network according to claim 1, characterized in that the signaling control unit further comprises:
an active code library; and
means for selecting active code in the library.

3. A network according to claim 2, characterized in that the signaling control unit (3) further comprises active code compilation means.

4. A network according to claim 1, characterized in that the signaling control unit (3) further comprises means for generating active code on the fly.

5. A network according to claim 1 adapted to use the Internet Protocol (IP).

6. A signaling method for use in a telecommunications network according to claim 1, comprising a step (8) of sending an appropriate active code from the signaling control unit (3) to the active node (11).

7. A method according to claim 6, comprising a step prior to the sending step of deciding on a strategy for sending of the appropriate active code by the signaling control unit.

8. A method according to claim 6, comprising a step prior to the sending step and optionally prior to the strategy decision step of the signaling control unit determining the appropriate active code.

9. A method according to claim 8, comprising a step prior to the determination step of negotiation between the terminals and the signaling control unit (3) of the characteristics of a communications session.

10. A method according to claim 6, comprising a step prior to the negotiation step of the signaling control unit receiving the virtual circuit request (5) and setting up the virtual circuit.

11. A method according to claim 8, wherein, when the control unit (3) comprises the active code library and selection means, the determination step comprises the selection by the control unit (3) of the appropriate active code in the library.

12. A method according to claim 8, wherein, when the control unit (3) comprises active code generation means, the determination step comprises the generation of the appropriate active code on the fly by the control unit (3).
